(19) United States
(12) Patent Application Publication
(10) Pub. No.: US 2013/0218678 A1
(43) Pub. Date: Aug. 22, 2013

(54) SYSTEMS AND METHODS FOR SELECTING AND GENERATING TARGETING INFORMATION FOR SPECIFIC ADVERTISEMENTS BASED UPON AFFINITY INFORMATION OBTAINED FROM AN ONLINE SOCIAL NETWORK

(71) Applicant: CitizenNet Inc, (US)

(72) Inventors: Daniel Benyamin, Los Angeles, CA (US); Arshavir Blackwell, West Hollywood, CA (US)

(73) Assignee: CitizenNet Inc, Los Angeles, CA (US)

(21) Appl. No.: 13/832,401

(22) Filed: Mar. 15, 2013

Related U.S. Application Data
(63) Continuation-in-part of application No. 13/331,950, filed on Dec. 20, 2011.
Application No. 13/331,950 is a continuation-in-part of application No. 13/277,209, filed on Oct. 19, 2011.
(60) Provisional application No. 61/639,709, filed on Apr. 27, 2012.
(60) Provisional application No. 61/394,484, filed on Oct. 19, 2010.

(51) Int. Cl. G06Q 30/02; G06Q 50/00

(52) U.S. Cl. CPC G06Q 30/0255; G06Q 50/01
USPC 705/14.53

(57) ABSTRACT

Systems and methods in accordance with embodiments of the invention can automatically generate advertising campaigns on an online social network using affinity information collected concerning members of one or more online social networks. In one embodiment, a method of targeting a piece of content as a paid advertisement within an online social network includes retrieving metrics with respect to engagement by members of an online social network, determining user affinities based upon the retrieved metrics, determining demographics of members of the online social network that have engaged with the pieces of content, identifying at least one cluster of members of the online social network based on the demographics, where the members are clustered based upon targeting information, and targeting at least one of the specific pieces of content as a paid advertisement targeted based on targeting information.

### CROSS-REFERENCE TO RELATED APPLICATIONS

The present application claims priority to U.S. Provisional Patent Application No. 61/639,709, entitled “Systems and Methods for Selecting and Generating Targeting Information for Specific Advertisements based upon Affinity Information Obtained from an Online Social Network” and filed Apr. 27, 2012. The present application further claims priority as a Continuation-In-Part of U.S. patent application Ser. No. 13/331,950 to Benyamin et al. entitled “Systems and Methods for Automatically Generating Campaigns using Advertising Targeting Information Based upon Affinity Information Obtained from an Online Social Network”, filed Dec. 20, 2011, which claims priority as a Continuation-In-Part of U.S. patent application Ser. No. 13/277,209 to Benyamin et al. entitled “Generation of Advertising Targeting Information Based Upon Affinity Information Obtained from an Online Social Network”, filed Oct. 19, 2011, which claims priority to U.S. Provisional Application Ser. No. 61/394,484 entitled “Generation of Advertising Targeting Information Based Upon Affinity Information Obtained from an Online Social Network”, filed Oct. 19, 2010. The disclosures of each of U.S. Provisional Patent Application No. 61/639,709, U.S. patent application Ser. No. 13/331,950, U.S. patent application Ser. No. 13/277,209, U.S. Provisional Application Ser. No. 61/394,484, and U.S. Provisional Application Ser. No. 61/425,235 to Benyamin et al. entitled “Systems and Methods for Automatically Generating Campaigns”, filed Dec. 20, 2010, are hereby incorporated by reference in their entirety.

### FIELD OF THE INVENTION

The present invention generally relates to online advertising and more specifically to the targeting of display advertising on social networks.

### BACKGROUND

Recent advances in online advertising have most prominently been in the field of behavioral targeting. Both web sites and networks tailor their online experiences to individuals or classes of individuals through behavioral targeting. When employed by advertising networks (“ad networks”), behavioral targeting matches advertisers that have a certain desired target audience with websites that have been profiled to draw a specific audience. One of the challenges in behavioral targeting is determining the true extent of the match between a desired audience and the actual audience drawn by a specific web page.

Online social networks, such as the Facebook service provided by Facebook, Inc. of Palo Alto, Calif., are ad networks that have very good knowledge of the visitors to specific pages within the online social network. In order to visit a page within a social network, one typically needs to be a member of the social network. In addition, members of social networks typically provide demographic information and information concerning interests in order to personalize their behavior. For example, a Facebook member could indicate that they are interested in ski vacations to Lake Tahoe by clicking a “Like” button featured on a Lake Tahoe website. A simple advertising strategy would be to target the members of an online social network who have previously indicated interest in the product or service being offered by the advertisement. A flaw with this strategy, however, is that many members that are interested in the advertised offer are not being targeted, because they have not previously indicated a desire for the products or services. More sophisticated advertising strategies attempt to build a demographic and/or geographic profile of a member that will be interested in the advertised offer and target the advertising to members matching the demographic and/or geographic profile. A campaign can be further targeted using keywords to narrow the audience for an ad to people who have interests, which correlate with the advertised offer. In many ad networks, advertisers can bid on keywords. Therefore, targeting users associated with a first keyword can cost significantly more money than targeting users associated with a second keyword. Returning to the example of an advertiser of ski travel packages to Lake Tahoe, the question becomes: who are others that may be interested in a Lake Tahoe vacation package beyond those that have specifically expressed an interest in such a vacation? Probably those who like specific ski resorts would be good candidates, and possibly those who like specific ski manufacturers. What about those who like gambling? Since the Lake Tahoe area also features a number of casinos, the desired audience for the offer could include members that like to ski and play poker. However, not all who like to play poker are good candidates for such a vacation package, and as such, advertisement budgets may not be wisely spent on such an audience. Therefore, challenges exist in selecting keywords that appropriately target specific offers to members of a social network.

### SUMMARY OF THE INVENTION

Systems and methods in accordance with embodiments of the invention can automatically generate advertising campaigns on an online social network using affinity information collected concerning members of one or more online social networks. In one embodiment, a method of targeting a piece of content as a paid advertisement within an online social network includes retrieving metrics with respect to engagement by members of an online social network with specific pieces of content posted by a member identifying members of a social network that engage with a piece of content using an advertising campaign creation system, determining user affinities based upon the retrieved metrics with respect engagement by members of the online social network using the advertising campaign creation system, determining demographics of members of the online social network that have engaged with the pieces of content using the advertising campaign creation system, identifying at least one cluster of members of the online social network based on the demographics of members of the online social network that have engaged with the pieces of content using the advertising campaign creation system, where the members are clustered based upon targeting information and the targeting information includes at least one targeting keyword and the members in a cluster of members are associated with a message having the targeting keyword, and targeting at least one of the specific pieces of content as a paid advertisement targeted based on targeting information associated with the at least one cluster of members of the online social network identified based on the demographics of members of the online social network using the advertising campaign creation system.

In an additional embodiment of the invention, retrieving metrics with respect to engagement by members of an online social network further includes retrieving the N most recently posted pieces of content by a member using the advertising campaign creation system.

In another embodiment of the invention, retrieving metrics with respect to engagement by members of an online social network further includes retrieving the best performing pieces of content posted by a member using the advertising campaign creation system.

In yet another additional embodiment of the invention, the retrieved metrics include information regarding the virality of the specific pieces of content posted by a member, where the virality of a piece of content is a measure of how many members of the online social network have posted a piece of content related to the specific piece of content posted by the member.

In still another additional embodiment of the invention, targeting at least one of the specific pieces of content as a paid advertisement further includes computing the distance between a piece of content and at least one cluster of members based on the keywords associated with the piece of content and the demographics of a cluster of members using the advertising campaign creation system and targeting the piece of content to a cluster of members when the piece of content is within a threshold distance from the cluster of members using the advertising campaign creation system.

In yet still another additional embodiment of the invention, targeting a piece of content further includes targeting a different set of advertising creatives for each cluster of members in the at least one of cluster of members using the advertising campaign creation system.

In yet another embodiment of the invention, targeting a piece of content further includes generating advertising content for a cluster of members based on the targeting information and the specific pieces of content targeted to the cluster of members using the advertising campaign creation system, where the advertising content includes at least one targeting keyword associated with the cluster of members.

In still another embodiment of the invention, the advertising content includes at least one of the targeted paid advertisements.

In yet still another embodiment of the invention, targeting a piece of content further includes generating an advertising campaign including the advertising content using the advertising campaign creation system and transmitting the advertising campaign to the online social network associated with the members using the advertising campaign creation system.

In yet another embodiment of the invention, targeting a piece of content further includes identifying additional relevant terms using messages posted to at least one social network based upon the targeted paid advertisements using the advertising campaign creation system and targeting additional pieces of content as paid advertisements targeted based on the additional relevant terms and the targeting information associated with the at least one cluster of members of the online social network identified based on the demographics of members of the online social network using the advertising campaign creation system.

Still another embodiment of the invention includes an advertising campaign creation system including a processor and memory connected to the processor and configured to store an advertising targeting application, wherein the advertising targeting application configures the processor to retrieve metrics with respect to engagement by members of an online social network with specific pieces of content posted by a member identifying members of a social network that engage with a piece of content, determine user affinities based upon the retrieved metrics with respect engagement by members of the online social network, determine demographics of members of the online social network that have engaged with the pieces of content, identify at least one cluster of members of the online social network based on the demographics of members of the online social network that have engaged with the pieces of content, where the members are clustered based upon targeting information and the targeting information includes at least one targeting keyword and the members in a cluster of members are associated with a message having the targeting keyword, and target at least one of the specific pieces of content as a paid advertisement targeted based on targeting information associated with the at least one cluster of members of the online social network identified based on the demographics of members of the online social network.

In yet another additional embodiment of the invention, the advertising targeting application configures the processor to retrieve metrics with respect to engagement by members of an online social network by retrieving the N most recently posted pieces of content by a member using the advertising campaign creation system.

In still another additional embodiment of the invention, the advertising targeting application configures the processor to retrieve metrics with respect to engagement by members of an online social network by retrieving the best performing pieces of content posted by a member using the advertising campaign creation system.

In yet still another additional embodiment of the invention, the retrieved metrics include information regarding the virality of the specific pieces of content posted by a member, where the virality of a piece of content is a measure of how many members of the online social network have posted a piece of content related to the specific piece of content posted by the member.

In yet another embodiment of the invention, the advertising targeting application configures the processor to target at least one of the specific pieces of content as a paid advertisement by computing the distance between a piece of content and at least one cluster of members based on the keywords associated with the piece of content and the demographics of a cluster of members and targeting the piece of content to a cluster of members when the piece of content is within a threshold distance from the cluster of members.

In still another embodiment of the invention, the advertising targeting application further configures the processor to target a different set of advertising creatives for each cluster of members in the at least one of cluster of members using the advertising campaign creation system.

In yet still another embodiment of the invention, the advertising targeting application further configures the processor to generate advertising content for a cluster of members based on the targeting information and the specific pieces of content targeted to the cluster of members, where the advertising content includes at least one targeting keyword associated with the cluster of members.

In yet another additional embodiment of the invention, the advertising content includes at least one of the targeted paid advertisements.

In still another additional embodiment of the invention, the advertising targeting application further configures the processor to generate an advertising campaign including the advertising content and transmit the advertising campaign to the online social network associated with the members.

In yet still another additional embodiment of the invention, the advertising targeting application further configures the processor to identify additional relevant terms using messages posted to at least one social network based upon the targeted paid advertisements and target additional pieces of content as paid advertisements targeted based on the additional relevant terms and the targeting information associated with the at least one cluster of members of the online social network identified based on the demographics of members of the online social network.

### BRIEF DESCRIPTION OF THE FIGURES

FIG. 1 is a network diagram showing an ad targeting system configured to generate targeting information for offers presented via an online social network in accordance with an embodiment of the invention.

FIG. 2 is a set diagram conceptually illustrating selection of keywords intended to reach a desired audience on a social network.

FIG. 3 is a flow chart showing a process for targeting advertising to a desired audience on a social network in accordance with an embodiment of the invention.

FIG. 4 is a flow chart showing a process for indexing user profiles for affinity to specific keywords in accordance with an embodiment of the invention.

FIG. 5 is a flow chart illustrating a process for identifying whether a short message indicates affinity for a specific keyword in accordance with an embodiment of the invention.

FIG. 5A is a flow chart illustrating another process for identifying whether a short message indicates affinity for a specific keyword in accordance with an embodiment of the invention.

FIG. 6 is a flow chart illustrating a process for determining a set of keywords that optimally covers a desired audience for an offer in accordance with an embodiment of the invention.

FIG. 7 is a flow chart illustrating a process for determining a set of keywords that optimally covers a desired audience for an offer using an index of members in accordance with an embodiment of the invention.

FIG. 8 is a flow chart illustrating a process for automatically building an advertising campaign using an advertising strategy and targeting information generated in accordance with embodiments of the invention.

FIG. 9 is a flow chart illustrating a process for selecting and generating targeting for specific advertisements in accordance with embodiments of the invention.

### DETAILED DESCRIPTION OF THE INVENTION

Turning now to the drawings, systems and methods for automatically generating advertising campaigns using affinity information collected concerning members of one or more online social networks and an advertising strategy in accordance with embodiments of the invention are illustrated. Affinity information is information concerning whether a member is positively (or negatively) disposed to something or someone. In many embodiments, the advertising targeting system identifies all keywords with which a desired audience is likely to have affinity and automatically determines a set of keywords for targeting an offer to the desired audience. In various embodiments, keywords with which a desired audience is likely to have affinity are automatically determined by identifying users that have affinity with specific keyword(s) that are the subject of the offer and identifying other keywords with which the identified users also have affinity. Stated another way, if a user expresses an affinity for an offer (or a keyword associated with the offer), then other keywords for which the user has affinity can be utilized to target advertisements to other users that are also likely to have an affinity to the offer. In several embodiments, a set of targeting keywords is determined by estimating the performance within an advertising campaign of advertisements targeted using a specific keyword or keyword combination. In a number of embodiments, performance is estimated by estimating click-through rates for advertisements targeted using a specific keyword or keyword combination. Performance can be estimated using a classifier that receives a feature vector for each keyword or keyword combination, where the feature vector is a measure of the ways in which the keyword or keyword combination is relevant to members that have previously expressed affinity for the subject of the offer or advertisement. In many embodiments, the feature vector captures trend information with respect to the keyword by performing frequency spectrum analysis on keyword frequency measurements taken over a period of time. In a number of embodiments, discrete Fourier transforms are utilized to perform frequency analysis. In many embodiments, the set of keywords is expanded to reach a broader audience by identifying additional keywords that are semantically similar to the keywords in a set of keywords identified as having a particular performance threshold (e.g. the best performing keywords or the optimal keywords).

Once affinity data has been collected, an advertising campaign creation process can commence. The advertising campaign creation process typically involves a user providing instructions to build advertisements in accordance with a strategy. Possible strategies include, but are not limited to, targeting fans of an offer (i.e. members of the social network that have expressed strong affinity to the offer) and/or targeting members interested in a competitor (i.e. members of the social network that have expressed affinity to a competitor). Strategies can also include determining weights related to the importance of members when generating targeting keywords. The strategies result in a number of advertising targeting groups, each with contextual information concerning the words and phrases used by the audience of users associated with the advertising group. Users can provide advertising content that may be related the adjectives and phrases surfaced from each target group. The system has already grouped a naturally occurring target audience, and allows the user to build a creative using a voice that resonates with the audience. Once the advertising content is created, the advertisements can be placed on an advertising network using the collected targeting information. Systems and methods for determining the affinity of members of an online social network with specific keywords, for automatically determining an effective and/or optimal set of keywords for targeting an offer, and for automatically building an advertising campaign in accordance with embodiments of the invention are discussed further below.

### Advertising Targeting

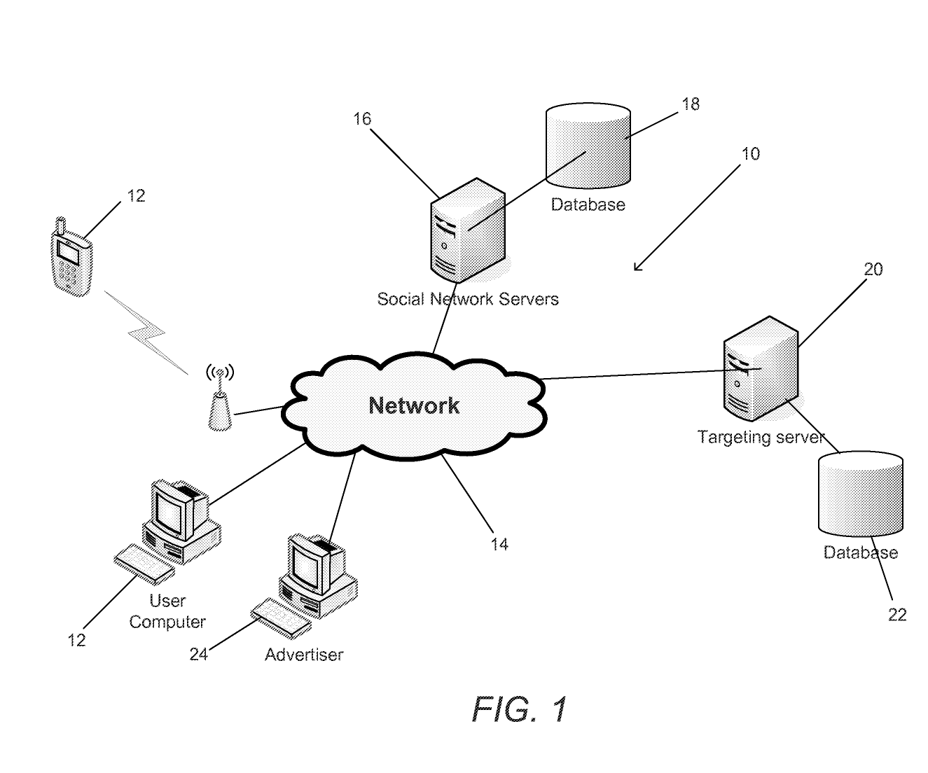

An advertising targeting system in accordance with an embodiment of the invention is illustrated in FIG. 1. In the advertising targeting system 10, users are able to utilize network devices 12 that are network 14 connected to communicate with servers 16 of one or more online social networks. A social network is a term that can be used to describe any online service where individual users can generate and/or upload content. In many instances, users can utilize an online social network to participate in the creation, review, and/or distribution of content. While the term online social network is commonly used to describe sites like the Facebook service provided by Facebook Inc. that have a highly social component, the term is equally applicable to an e-commerce website that provides the ability for users to post reviews and/or any other sites that allow users and/or members to post any form of content. Typically, an online social network includes a database 18 containing profile pages of members of the online social network that is updated in real time by user activities such as status updates, and various other forms of content uploaded to the online social network via users. In many instances, APIs enable third parties to obtain information or data from the online social network concerning member profiles and activities performed by members (i.e. activities associated with a member profile) and provide applications such as online social games via an online social network. In the illustrated embodiment, a targeting server 20 is configured to access profile information including activities associated with the profiles from the servers within the online social network via such APIs or similar mechanisms. The data obtained by the targeting server can be processed and utilized to build a database of member profiles including demographic information and associate affinities with specific keywords with member profiles. Demographic information includes a variety of data regarding members such as gender, age, ethnicity, language knowledge, location, employment status, relationship status, and any other information about a member that can be utilized to generate statistics about the members of an online social network as appropriate to the requirements of a specific application in accordance with embodiments of the invention. In many embodiments, the targeting server generates affinity information for a subset of the members of the online social network by processing the activity data associated with the member profiles of the subset of members of the online social network. The larger the size of the subset, the more likely that subset is representative of all of the members of the online social network. In several embodiments, the targeting server attempts to generate affinity information for all of the members of the online social network. The targeting server 20 (or another related server) can be utilized to automatically generate an advertising campaign by selecting member profiles according to an advertising strategy and then building targeting data to target members in accordance with the advertising strategy.

When an advertiser attempts to present an offer to members of the online social network, the advertiser can utilize a computing device 24 to provide information concerning the offer to the targeting server 20 and the targeting server can generate a listing of targeting keywords that will optimally target the offer to members of the online social network based upon the affinity information and an advertising strategy. In many embodiments, an optimality criterion is used in the generation of the targeting keywords that attempts to identify a set of keywords that will reach a desired audience. The advertising strategy can be utilized to define weights or filters to apply to member profiles when generating targeting keywords. In several embodiments, the optimality criterion also considers other objectives including (but not limited to) minimizing the extent to which individual members of the online social network are targeted multiple times by the targeting keywords and/or the extent to which members that are unlikely to be interested in the offer are targeted by the targeting keywords. In many embodiments, the optimality criterion also attempts to minimize the number of keywords included in the list of targeting keywords. In a number of embodiments, the optimality criterion utilizes information concerning the relative cost of using individual keywords in targeted advertising and attempts to identify the set of keywords that will reach the desired audience while minimizing multiple targeting of individual members and/or the targeting of members disinterested in the offer at the lowest cost. In several embodiments, a classifier such as (but not limited to) a neural network is utilized to predict the impact of a keyword (e.g. predicting click-through rates) and these predictions are utilized to select an optimal set of targeting keywords. Predicting keyword impact typically depends upon the requirement of a specific targeting system and the offers targeted by the targeting system.

As is discussed further below, a variety of criteria can be utilized in the selection of targeting keywords based upon affinities expressed by individual users. It should be appreciated that the term optimality in this context refers to optimization with respect to a specific criterion used in the selection of the keywords. Indeed, the complexity of identifying targeting keywords in the context of online social networks arises due to the fact that the desired audience is unknown. Therefore, any optimality criterion can only ever provide a “best” estimate based upon assumptions inherent within the specified criterion.

### Selecting Keywords Covering a Desired Audience

Targeting the presentation of offers to members of an online social network is a complex problem. Perfect targeting information would only present the offer to members of the online social network that further a defined advertising strategy, would not present the offer to any members that were not interested in the offer, and can potentially involve allocating ad impressions evenly across the desired audience. Obtaining perfect targeting for presentation of an offer via an online social network is difficult as online social networks rarely directly provide information concerning the current interests of members. In the context of online search advertising, advertising can be targeted based upon the expressed desire of the user for information on a specific topic. Members of online social networks can express affinity for a specific product or service via a mechanism such as a status update or a short message (e.g. a “Tweet” via the Twitter service provided by Twitter, Inc. of San Francisco, Calif.). As noted above, however, the set of members of an online social network that are likely to be interested in a specific offer typically is not limited to the members that have previously expressed an interest in the offered product or service. Therefore, targeting systems in accordance with many embodiments of the invention attempt to identify a targeting combination that is likely to target advertising to a desired audience based at least upon the affinity to keywords of members of an online social network that have previously expressed affinity to the offer. Processes for targeting keywords based upon the affinity to specific keywords of members of a social network that have previously expressed affinity for an offer in accordance with embodiments of the invention are discussed below.

Processes for Targeting Advertising using Optimal Keywords

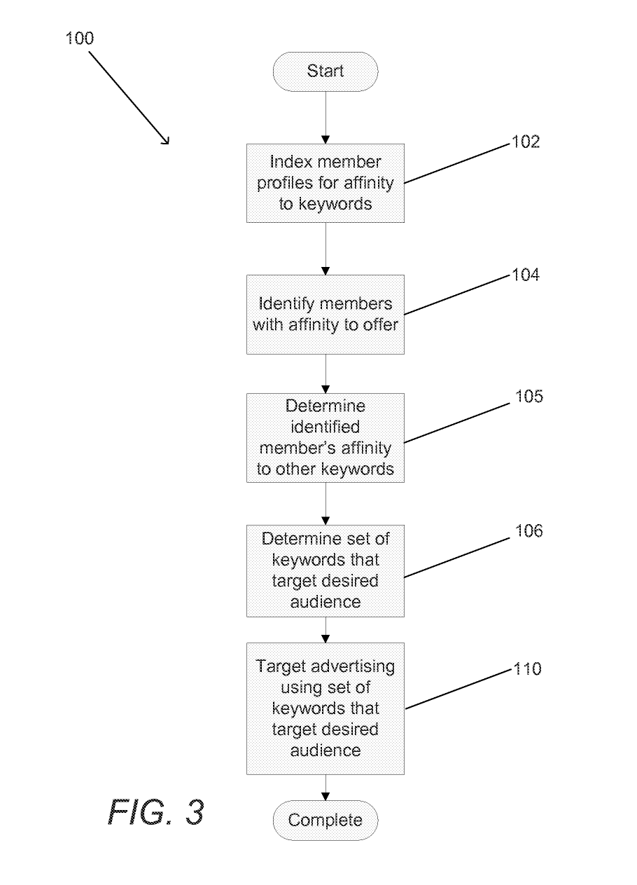

In order for an advertising targeting system in accordance with an embodiment of the invention to select targeting keywords that optimally target an offer or advertisement to a desired audience in accordance with defined a defined advertising strategy, the targeting system determines the affinity to specific keywords of members of an online social network that have previously expressed affinity to the offer. A process for targeting advertising to a desired audience by identifying the affinity to keywords of members of a social network that have previously expressed affinity to an offer in accordance with an embodiment of the invention is illustrated in FIG. 3. The process 100 includes indexing (102) member or user profiles within one or more social networks for affinity to keywords. Once a database has been obtained that captures the affinity between specific members and specific keywords, members are identified that have expressed affinity to the subject of a specific offer (104) and then other keywords for which those members have expressed affinity are identified (105). In several embodiments, the process assumes that the keywords for which the identified members have expressed affinity target other members of the desired audience (i.e. members of the social network likely to be interested in the offer). In many other embodiments of the invention, the keyword(s) utilized to determine affinities between a member and an offer may generated by hand or generated automatically using natural language processing techniques to analyze the offer and web pages or other sites associated with the offer and/or analysis of the affinities of members who have historically accepted such offers. In many embodiments, the affinity of a member to an offer is determined by determining the affinity of the user to the keyword or keywords that is the subject of the offer or advertisement (e.g. a title of a movie).

Based upon all of the keyword affinities expressed by the members identified using the initial list of keywords, a set of targeting keywords is determined (106) to target the desired audience. In many embodiments, the members used to generate the initial list of keywords are weighted in accordance with a defined advertising strategy to obtain targeting keywords that are more likely to target members that are the focus of the advertising strategy. In many embodiments, the set of targeting keywords can be determined by estimating the likely click through rates of advertisements targeted using specific targeting keywords. Advertising is then presented to members of the online social network targeted (110) using the targeting keywords and/or other demographic information.

Although a specific process for targeting advertising is described above with respect to FIG. 3, any of a variety of processes can be utilized to target advertising using keywords selected based upon at least the affinity to specific keywords of members of one or more social networks that have previously expressed affinity to the subject of the advertisement that are appropriate to a specific application in accordance with embodiments of the invention. Processes for determining affinity between members and a specific keyword and for predicting the effectiveness of specific keywords in targeting a desired audience are discussed further below.

### Indexing User Affinities

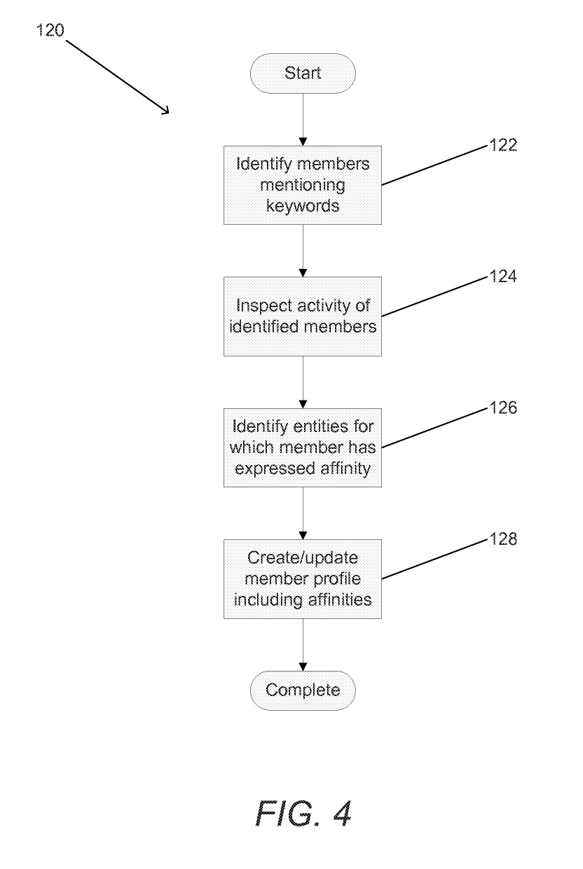

In many embodiments, an index of member affinities is built in response to a request for targeting information based upon a specific offer. In a number of embodiments, processes for determining the affinity of members of one or more social networks to a set of keywords and automatically determining a set of targeting keywords for targeting specific offers to members of the social network are performed asynchronously. In several embodiments, however, the process of indexing affinities expressed by users is performed continuously to reflect the continuous activity of members of online social networks and the database is then utilized on an ongoing basis by an advertising targeting system. A process for indexing member profiles for affinity to specific keywords is illustrated in FIG. 4. The process 120 includes identifying (122) members mentioning keywords via an online social network. The activity of the member is then inspected (124) to identify (126) entities for which the member has expressed affinity. In several embodiments, the additional activity is requested from the online social network via an API. A member profile is then created and/or updated (128) within a database to include the identified affinities. In several embodiments, additional information is collected in the database including but not limited to First Name, Last Name, User ID, the service (where multiple online social networks are indexed in a single database), age, sex and/or geographic location. In this way, the database provides an up to date list of all of the affinities of members identified using the initial set of keywords. As is discussed further below, these affinities then become the basis for determining targeting information in accordance with an advertising strategy.

### Identifying Expressions of Affinity

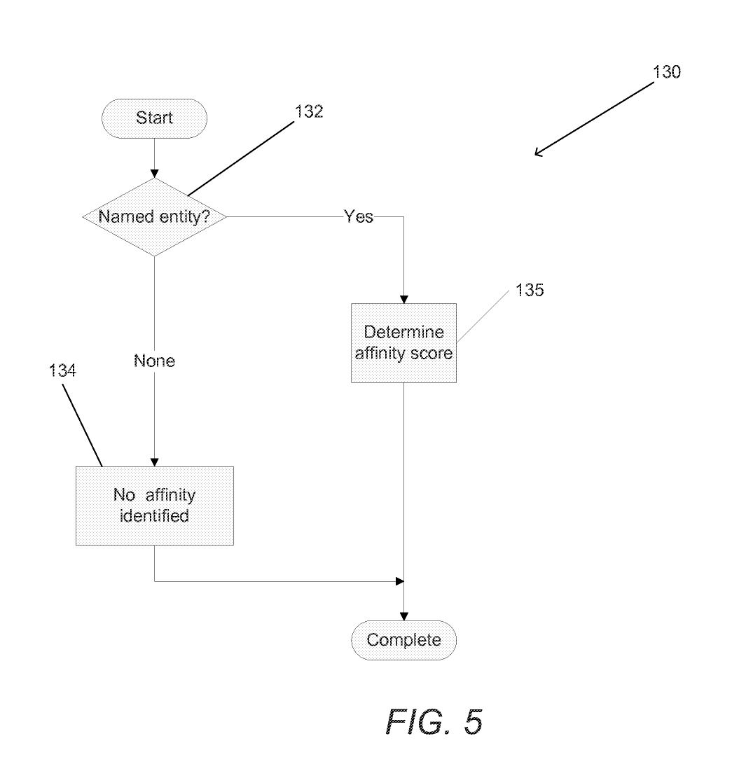

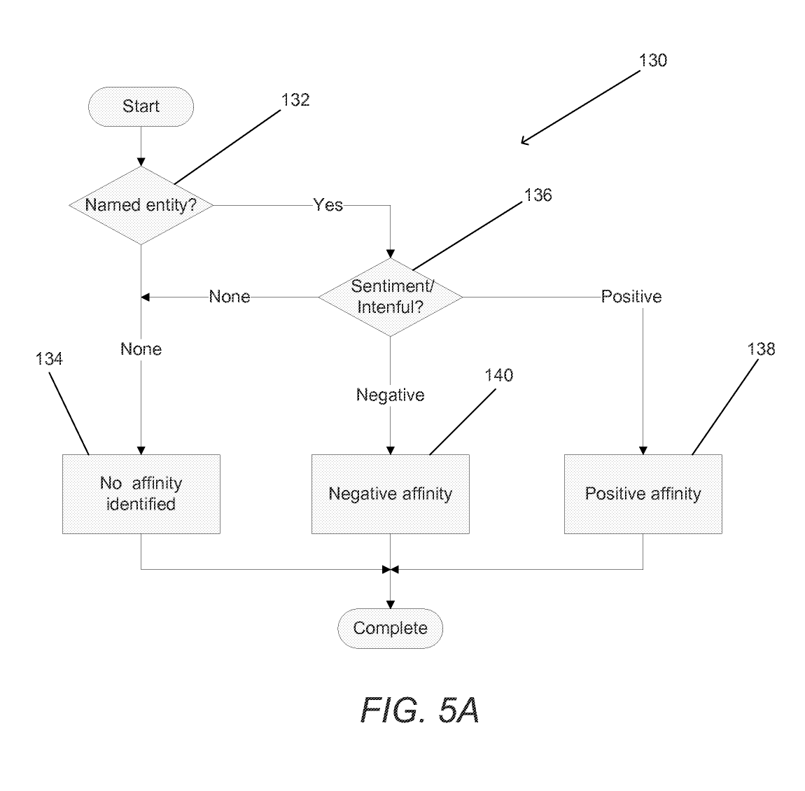

Any of a variety of processes in accordance with embodiments of the invention can be utilized to analyze the activities of users of an online social network to determine whether specific members are expressing affinities for a particular keyword. One process for determining whether an activity expresses affinity with a specific keyword in accordance with an embodiment of the invention is illustrated in FIG. 5. The process 130 involves analyzing data describing activities performed on an online social network to determine (132) if the activity involves, references, and/or relates to a named entity, such as a person, place or thing. In the context of online social networks, an activity includes (but is not limited to) commenting, voting, reviewing, rating, purchasing, launching, listening, propagating content, viewing content and/or any other interaction supported by a specific online social network. In many embodiments, the determination is made by identifying whether the activity includes any word that matches a database of named entities such as the Freebase knowledge base of people, places and things provided by Google, Inc. In the illustrated embodiment, the set of keyword affinities that can be indexed is limited to named entities. In other embodiments, a more expansive or a more restrictive set of keywords can be indexed. If the activity does not include a named entity, then the process determines (134) that no affinity is expressed by the activity. In the event that the activity includes a named entity, then the process determines (135) whether the activity expresses affinity for the named entity. In several embodiments, affinity to keywords is determined based upon sentiment and/or intent expressed by an activity performed by the member of the social network (see discussion below). In many embodiments of the invention, an affinity score is determined utilizing a process similar to the processes disclosed in U.S. patent application Ser. No. 13/103,990 entitled “Systems and Methods for Measuring Consumer Affinity and Predicting Business Outcomes Using Social Network Activity” to Benyamin et al., filed Mar. 9, 2011, the disclosure of which is incorporated by reference herein in its entirety. The affinity score can be combined with other factors, including a threshold factor based on the specific keyword.

In many other embodiments, a determination of affinity is expressed based upon an expression of a positive (or negative) sentiment and/or an expression that is “intentful” (i.e. expresses an intention to perform an action with respect to the named entity). An embodiment of a process that attempt to determine and categorize affinity in accordance with an embodiment of the invention is shown in FIG. 5A. In the event that the activity expresses no clear affinity, the activity is classified (134) as not expressing an affinity. In the event a positive affinity is expressed, the activity is classified (138) as expressing a positive affinity with respect to the named entity. As noted above, the expression of positive affinity to the named entity can then be associated with the targeting system's profile of the member responsible for the activity. Similarly, when a negative affinity is expressed, the activity is classified (140) as expressing a negative affinity with respect to the named entity and a negative affinity to the named entity can be associated with the member's profile in the targeting system.

Although specific processes are illustrated in FIG. 5 and FIG. 5A for determining whether an activity contains an expression of affinity with respect to a specific keyword, other processes appropriate to the requirements of a specific application, including but not limited to processes that only detect positive affinity, can also be utilized in accordance with embodiments of the invention. Various processes for detecting sentiment and intent with respect to a specific keyword are discussed further below.

### Determining Sentiment

In a number of embodiments, sentiment can be determined by building a statistical classifier. A statistical classifier can be constructed using a training data set in which each activity is classified as expressing a positive sentiment, negative sentiment, and in many instances no clear sentiment. Words in the training data set of activities can then be matched with a set of strongly polarizing sentiment words, which may be generated by hand and can include emoticons (i.e. combinations of characters that form symbols used to indicate sentiment and/or emotion). Examples of strongly polarized words include, but are not limited to, “love”, “hate”, “adore”, and “despise”. Depending upon context, such words do not necessarily convey positive or negative sentiment (e.g. “I could never love . . . ”). A list of individual words and word pairs can then be generated ignoring the strongly polarized words and the named entity in each activity. The activities can then be provided to a sentence parser, such as the Stanford parser distributed by the Stanford Natural Language Processing Group at Stanford University, to generate a list of grammatical relationships between the words in the list and the named entity. The lists of single words, word pairs, and grammatical relationships can then be used to train a statistical classifier. In many embodiments, the statistical classifier is a maximum entropy classifier. In a number of embodiments, other types of statistical classifiers including, but not limited to, a Bayesian or Naïve-Bayesian classifier can be utilized.

In several embodiments, separate statistical classifiers can be created depending upon categorization of the topic of a specific activity. For example, separate classifiers can be created for the categories sports, music, and politics. In many instances, different words and different word relationships are used to express sentiment in different contents and these differences can be captured using the different statistical classifiers. The categorization of short messages is described in U.S. patent application Ser. No. 12/781,799, titled “Social Network Message Categorization Systems and Methods” and filed May 17, 2010, the disclosure of which is incorporated by reference herein in its entirety.

### Identifying “Intentful” Expressions

In many embodiments, a determination is made concerning whether an activity expresses intent with respect to a named entity by comparing the words in the activity to a list of intentful verbs. In several embodiments, the topic of the activity is determined and a separate list of intentful verbs is provided for each topic. In a number of embodiments, the activity is also provided to a sentence parser to identify the named entity that is the subject of the intentful verb. In other embodiments, any of a variety of techniques can be used to generate a list of intentful verbs and/or to determine whether intent with respect to a specific named entity is expressed within an activity.

### Determining an Optimal Set of Keywords for Targeting an Offer

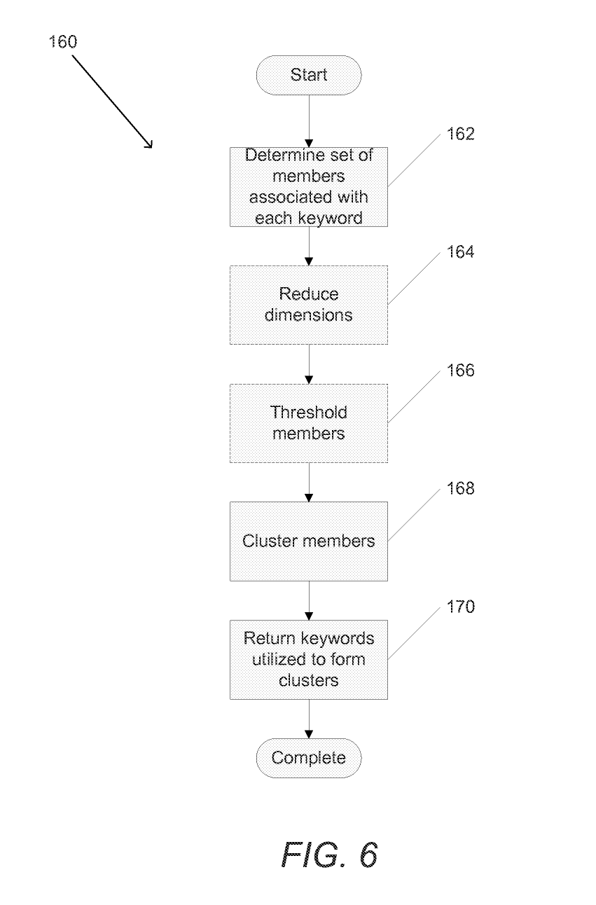

A process for determining a set of targeting keywords for targeting an offer to members of an online social network using information concerning affinities between specific users and specific keywords in accordance with an embodiment of the invention is illustrated in FIG. 6. As noted above, the targeting process involves identifying members of one or more social networks that have expressed affinity for a keyword or list of keywords associated with an offer and then determining a list of additional keywords for which the identified members have also expressed affinity (162). In many embodiments, after the database of affinities between specific members and specific keywords has been created, the database can be queried to identify the members targeted by specific keywords or specific combinations of keywords. In many embodiments the identified members can be clustered; clustering provides insights concerning distinct segments of the desired audience and can facilitate the selection of a set of targeting keywords that target members of online social networks falling within each of the segments, not just segments strongly represented by the members identified using the offer keyword(s).

Typically, a database generated in accordance with embodiments of the invention is sparse and so the dimensionality of the data within the database concerning the identified members can be reduced (164). In many embodiments of the invention, the dimension of the group of members retrieved can be reduced using random projection. In other embodiments of the invention, any of a variety of processes appropriate for reducing the dimensionality of a dataset can be used to reduce the dimensionality and improve the ability of the process to cluster members that have expressed affinity to the object.

A threshold can be applied to the group of members retrieved (166) to further reduce the size of the group considered by the process. In several embodiments of the invention, the threshold can be based on positive affinity for a given keyword or combination of keywords. In a number of embodiments of the invention, the threshold can be based on a negative affinity for a given keyword or combination of keywords. In several embodiments of the invention, the threshold can be based on demographic attributes. In many embodiments, the threshold can be based on topics which the members have previously discussed. In still other embodiments, the threshold can be based on a combination of factors.

Members can be clustered together into groups based on demographic information and their affinity for specific keywords or combinations of keywords (168). In many embodiments of the invention, a growing hierarchical self-organizing map is used to cluster members. In other embodiments, any of a variety of clustering algorithms appropriate to a specific application can be utilized in accordance with an embodiment of the invention. During clustering, groups of members can be formed based upon demographic information and specific keywords or groups of keywords for which the members have affinity. The clusters can then be utilized to score keywords (or keyword combinations) to generate a set of demographic information and/or keywords that target a desired audience. In many embodiments, a keyword or keyword combination is scored by generating a feature vector that describes relevant characteristics of the keyword. For example, the feature vector can include the Jaccard index of the keyword as a measure of the extent to which the members targeted by the keyword includes members that have previously expressed affinity for the subject to an offer or advertisement. The feature vector can be dependent upon the characteristics of the offer (i.e. the offer keyword(s)), the cluster, the keyword itself and/or other keywords. Relating the keyword to the cluster in the feature vector can enable a classifier to determine the extent to which a keyword is relevant to targeting an offer to a specific group within the desired audience. Therefore, keywords that particularly resonate with a specific demographic (for example women aged 35-44) can be identified and utilized in the targeting of advertising. The ability to target advertising to specific segments making up a desired audience can be useful where the members that have expressed affinity to an offer keyword(s) are not evenly distributed across the segments of the desired audience. In addition, the clusters enable the selection of set of keywords that target each of the segments of the desired audience and reduces the likelihood that targeting keywords will be selected that strongly target discrete segments within the desired audience. The feature vector need not be limited to a single measure and any of a variety of measures can be utilized to measure the extent to which a keyword targets a portion of a desired audience in accordance with embodiments of the invention. In this way, the clusters provide insight into the keywords that are most likely to target members of a desired audience and, as is discussed further below, can be used to select targeting demographic information and/or keywords for use in targeting an advertising campaign. The set of targeting keywords can then be returned (170) by the targeting system and provided to the online social network by the advertiser to enable the targeting of the offer.

### Trend Data

By looking at all the activities logged over a period of time, observations can be made concerning underlying trends. In several embodiments, trends are detected by looking at the frequency of occurrence of each unique word contained in observed activities. In many embodiments, the frequencies of two or more words are analyzed to determine the number of mentions of a complete phrase. With the counts of words or phrases over a discrete period of time, a Discrete Fourier Transform (or other discrete transformation) can be performed on the time series of each word. The resulting spectrum can be used to show the presence of low, medium or high frequency trends.

Low frequency trends indicate some fairly consistent use of a word, such as a word commonly used in conversation, and these words bear little information. High frequency trends indicate a significant use of a word over the time period analyzed. For example, if there was a big sale on cars, then the word “sale” would generate a large spike on the day the sale was announced. In many instances, these trends may be disregarded. Medium frequency trends can provide a great deal of information concerning words or phrases that come in and out of usage. For example, if there was a recall on a specific model of car, then phrases like “safety concerns” would appear with varying rates. In this way, medium frequency trend information obtained by performing a Discrete Fourier Transform can be utilized to single out interesting and not readily apparent trends. In many embodiments, the frequency and amplitude of a keyword is included as part of the feature vector of the keyword.

Although specific processes are described above for identifying trends, any of a variety of processes including (but not limited to) processes that use various techniques to determine counts and/or frequencies of occurrence of keywords can be utilized in accordance with embodiments of the invention.

### Selecting Targeting Keywords

A variety of techniques can be utilized to identify keywords for which members of a desired audience are likely to have affinity. In many embodiments, specific targeting keywords are selected from the group of keywords for which a desired audience is likely to have affinity by estimating the performance of the keywords with respect to a specific advertising campaign and then selecting the highest performing keywords. In a number of embodiments, the performance of a specific keyword or combination of keywords within a campaign is determined using a classifier that is trained to predict the performance of keywords within a campaign based upon feature vectors assigned to the keywords using a process similar to any of the processes outlined above. In many embodiments, the performance of a targeting keyword can be defined as the click-through rate for advertisements displayed within a social network based upon the targeting keywords. In several embodiments a neural network is utilized to score the expected click-through rate of keywords based upon their feature vectors. The click-through rate predictions in combination with the budget for the advertising campaign can be utilized to determine the keywords and/or keyword combinations that will reach the largest audience.

In the event that the identified keywords and/or keyword combinations are unlikely to reach a sufficiently large number of members of the social network, then the set of targeting keywords that the classifier estimates will perform well in the advertising campaign can be utilized to identify additional targeting keywords. In a number of embodiments the targeting system can run an initial campaign with the objective of stimulating additional activity with respect to the subject of the campaign. The additional activity contributes to an expanded set of data that can provide additional insights into the keywords for which members of the desired audience are likely to have affinity. In many embodiments, the targeting keywords are utilized to identify similar keywords that can be utilized as targeting keywords. In several embodiments, web pages (or other data sources) containing semantic information concerning a targeting keyword or a combination of targeting keywords can be processed using natural language processing techniques to identify keywords that have the same or a sufficiently similar meaning to be useful in targeting advertising. For example, a targeting system can review a Wikipedia entry related to a keyword or keyword combination and identify other named entities on the Wikipedia pages. The affinity of members in the desired audience to these keywords can be measured. In other embodiments, a predetermined number of web pages can be processed and the affinity of members within the desired audience to entities listed on the web pages measured.

Although specific processes are discussed above with respect to the selection of targeting keywords from a set of keywords that are likely to identify members of a desired audience, any of a variety of processes appropriate to a specific application can be utilized in accordance with an embodiment of the invention.

### Targeting Using Set Covering

Targeting systems in accordance with embodiments of the invention are described above that identify members of social networks that have previously expressed an affinity for a particular offer and use that information to determine targeting keywords that are likely to target the entire audience of members of the social network(s) that are likely to be interested in a particular offer. In many embodiments, the targeting systems build an optimal targeting combination using a variant of a process known as set covering. A set covering problem is typically regarded as being any problem that can be formulated in terms of a given universe including a family of subsets within the universe, where the solution involves determining the minimum number of subsets that cover the entire universe. The targeting problem is more complex in that the desired audience is an unknown subset of the universe of members, and the subsets associated with each of the keywords are usually approximated based upon a sample of the members that make up the universe of members. However, similarity exists in that the goal of the targeting problem is to select the subsets (i.e. the keywords) that cover what is estimated to be the desired audience in accordance with a predetermined optimality criterion.

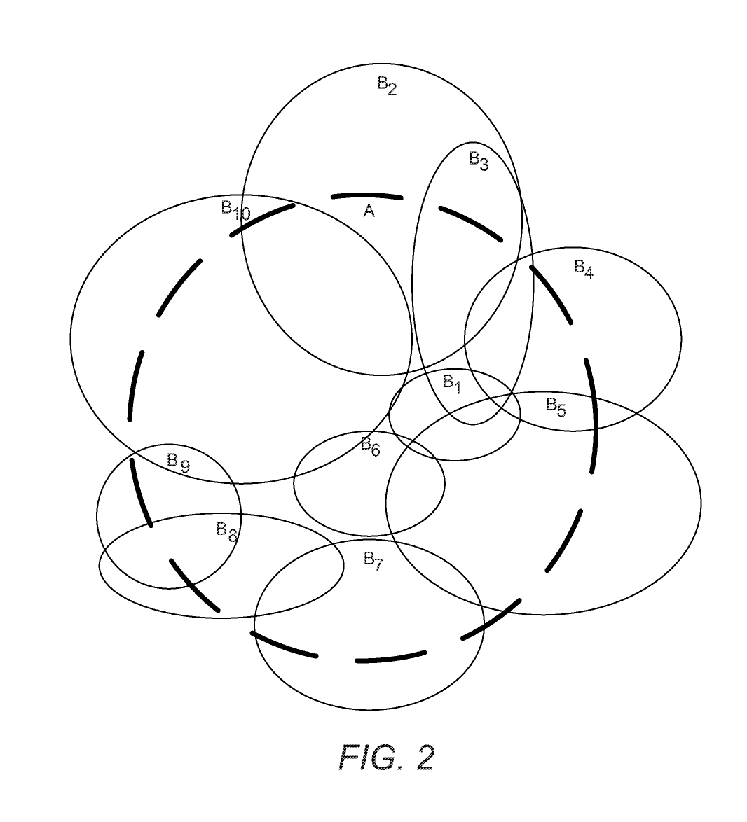

The formulation of keyword targeting as a variant of the set covering problem is illustrated in FIG. 2. An estimate of the desired audience (A) is indicated by a dashed line and members targeted by keywords B₁, . . . , B₁₀ are indicated by the sets B₁, . . . , B₁₀. In the standard set covering problem, the objective is simply to span the universe using the smallest number of subsets. When selecting targeting keywords, the optimality problem can be significantly more complex as certain keywords can be more expensive, overlaps between the members targeted by specific keywords can be desirable and keywords that target significant numbers of members that are not part of the desired audience can also be undesirable.

In a number of embodiments, targeting keywords can be selected by selecting the keywords (i.e. B₁, . . . Bₙ) that minimize the following cost function:

$$Score = \vert A \vert - {\sum }_{n} \vert A \vert {B}_{n} \vert + {\sum }_{n , m} \vert {B}_{m} \vert {B}_{n} \vert + {\sum }_{n} ( \vert {B}_{n} \vert - \vert A \vert {B}_{n} \vert )$$

The above cost function measures the extent to which the keywords target the desired audience. The score is decreased by the extent to which the keywords cover the desired audience (i.e. the second term of the cost function) and the score is increased by the extent to which specific keywords target the same people (i.e. the third term of the cost function). The score is also increased by the extent to which specific keywords target people, who are not within the desired audience (i.e. the fourth term of the cost function). Ideally, a set of keywords would only target the desired audience, and the keywords would not target any of the same people. In which case, the score would be 0. Although a specific cost function is presented above other cost functions can be utilized as appropriate to the requirements of a specific application in accordance with embodiments of the invention.

As noted above, many ad networks operate on an auction model, where the price paid for advertising is determined by competition with other advertisers. Targeting systems in accordance with embodiments of the invention can store the cost (Cₙ) associated with each keyword for which a user has expressed affinity and can use cost as a criterion when selecting targeting keywords. In several embodiments, the optimality criterion includes a cost function that accounts for the cost of specific keywords and/or errors in the approximations of the set of members that are targeted by specific keywords such as, but not limited to, the following cost function:

$$Score = \vert A \vert - \text{?} \text{?} \cdot \vert A ⋂ \text{?} \vert + \text{?} \vert \text{?} \text{?} \vert + \text{?} ( \vert \text{?} \vert - \vert A ⋂ \text{?} \vert ) + E \cdot N$$

$$\text{?} \text{indicates text missing or illegible when filed}$$

where N is the number of keywords used to cover the desired audience.

Any of a number of known algorithms can be utilized in the optimization of the above cost functions including a greedy algorithm and other algorithms that produce acceptable (although potentially sub-optimal) solutions with reduced processing overhead compared to an algorithm that produces an optimal solution.

Although specific cost functions and optimization techniques are discussed above, alternative cost functions including, but not limited to, cost functions that include after the fact information (such as ad performance) can also be utilized in accordance with embodiments of the invention. Processes for selecting targeting keywords and for estimating members targeted by specific keywords are discussed further below.

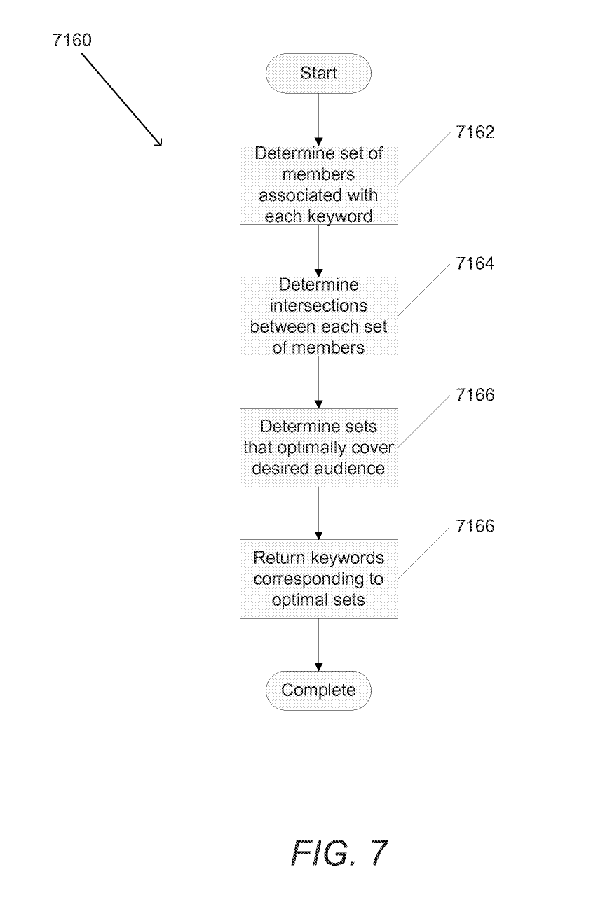

A process for determining an optimal set of keywords for targeting an offer to members of an online social network using information concerning affinities between specific users and specific keywords in accordance with an embodiment of the invention is illustrated in FIG. 7. As noted above, the targeting process involves determining a list of all keywords for which members identified by an initial set of keywords related to an offer have expressed affinity. The process 7160 involves determining (7162) the number of members that have expressed affinity to each keyword on the list and determining (7164) the number of members that have expressed affinity for each pair of keywords on the list. These counts can then be used in combination with other information, including, but not limited to, the relative cost of each keyword, to determine (7166) a set of keywords that optimally targets the desired audience utilizing a cost function similar to the cost functions discussed above. The optimal set of keywords can then be returned (7168) by the targeting system and provided to the online social network by the advertiser to enable the targeting of the offer.

The process described with respect to FIG. 7 relies upon the creation of an index of members that is a statistically significant sample of the universe of members of a specific online social network. In several embodiments, a list of N keywords is manually generated or generated by natural language processing of relevant sources of information and then the list is used to query a web indexing service, such as the Google service provided by Google, Inc., using each keyword and each pair of keywords and then counting the number of “hits” within a social networking service. Such a process can be more computationally efficient for a targeting system; however, the process relies upon the extent to which the web indexing service is caching and/or indexing activity on the social network. Therefore, the number of hits may not be a reliable indication of the extent to which a specific keyword targets members of an online social network.

In many instances, audience splitting can be used to provide more accurate matches within specific demographic categories. When sufficiently rich indexing information is acquired, a targeting system can independently optimize for different audiences based upon demographics and compare the predicted effectiveness of the offers based upon the normalized cost functions of the optimal targeting information for each demographic (i.e. comparing measures of how well the targeting keywords match the desired audience in each demographic). In this way, the amount of advertising targeted (and/or presented) to different demographics can be determined based upon the predicted performance of advertising targeting each demographic. The numbers of “hits” can then be utilized in the selection of an optimal set of keywords in the manner outlined above.

### Building an Advertising Campaign Using an Advertising Strategy

Advertising campaign creation processes in accordance with embodiments of the invention involve a user providing an advertising strategy that can be utilized to target advertising to a desired target audience. Possible strategies include, but are not limited to, targeting fans of an offer (i.e. members of the social network that have expressed strong affinity to an offer of named entity), target members interested in a competitor (i.e. members of the social network that have expressed affinity to a competitor of the named entity), target members interested in an industry (i.e. members of the social network that have expressed affinity with keywords and/or named entities strongly associated with a specific industry), and addressing negativity within an online social network (i.e. targeting members that have expressed a negative affinity to an offer or named entity). In a variety of embodiments, the strategies are implemented by applying weights to targeted members to skew the targeting information used to generate an advertising campaign to achieving a specific objective. The strategies that can be employed are only limited to the extent that they can be expressed as weightings with respect to specific profiled members of a social network and can include complex strategies such as (but not limited to) differentiating an offer from competitors (i.e. giving a higher weighting to members “furthest” from one or more clusters of members).

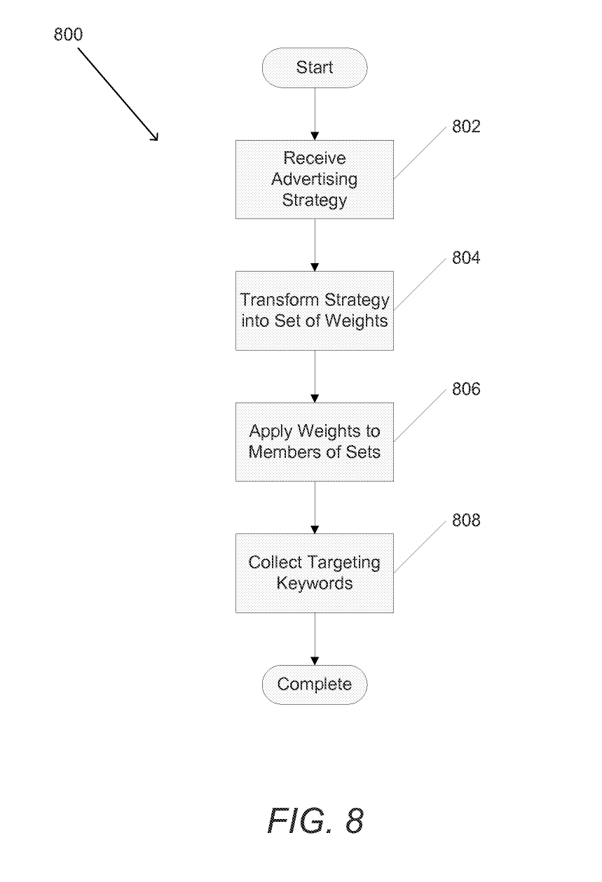

A process for automatically generating an advertising campaign in accordance with an embodiment of the invention is illustrated in FIG. 8. The process 800 assumes that clusters of members of one or more social networks have been formed using information concerning affinities between specific users and specific keywords. An advertising strategy is received (802) from a user and the advertising strategy is transformed (804) into a set of weights that are applied to the members in the clusters. Processes similar to those outlined above can then be used to generate targeting keywords that target the members of the clusters in a manner that reflects the weights assigned to each member by the advertising strategy.

Weighting (806) members when generating targeting information results in a number of advertising targeting groups, each with contextual information concerning the words and phrases used by that audience. In many embodiments, the user is alerted that these targets and pieces of contextual information are ready, which may be days or weeks after the user initially started collecting targeting information. The user can provide advertising content that can be inspired by the adjectives and phrases surfaced from each group. In a variety of embodiments, a naturally occurring target audience has already been grouped, allowing the user to build a creative using a voice that resonates with the target audience. Once the advertising content is created, the advertisements are ready to be placed on an advertising network using the collected (808) targeting information.

Although a specific process for automatically generating an advertising campaign in accordance with an embodiment of the invention is illustrated in FIG. 8 any of a variety of processes can be utilized that modify the targeting information returned using affinity information based upon specific advertising strategies in accordance with embodiments of the invention.

### Selecting and Generating Target Users for Specific Advertisements

Many social networking services are extending the concepts of traditional advertising by allowing any piece of content (e.g. text, URLs, URIs, audio, video, images, “likes”) posted to the social network to receive paid sponsorship for additional exposure. For example, Facebook offers a service called “Sponsored Stories”, whereby pieces of content provided to the Facebook servers by a member of the Facebook online social network can be converted into advertisements. In a number of embodiments, the characteristics of members that have already engaged with a piece of content can be determined and utilized to select the pieces of content that can be effectively targeted as an advertisement to a desired audience.

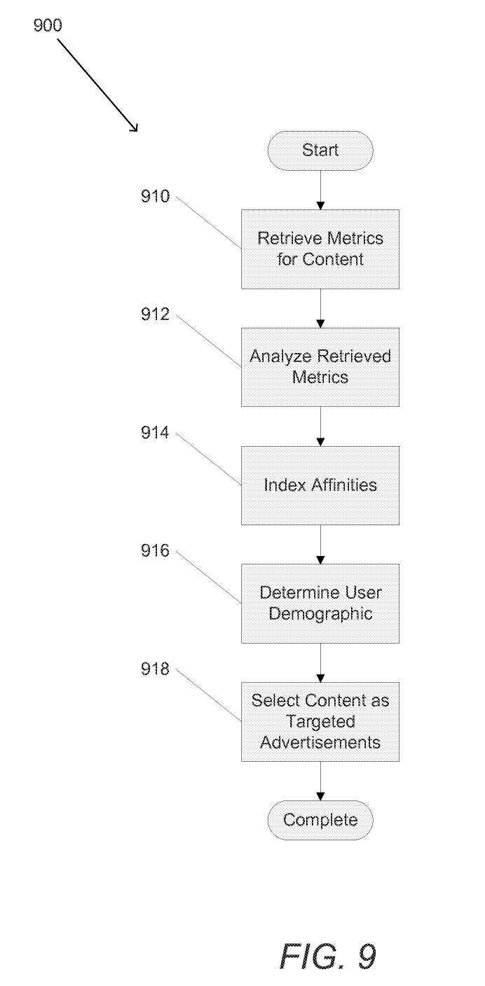

A process for selecting and generating information concerning the users or members of an online social network that a piece of content is likely to target when converted into an advertisement in accordance with an embodiment of the invention is illustrated in FIG. 9. The process 900 involves retrieving (910) metrics with respect to the manner in which members of the online social network engage with specific pieces of content posted by a member (sponsored or otherwise). In a number of embodiments, retrieval (910) of metrics is performed for the N most recently posted pieces of content, where N is a predetermined number or can be determined dynamically based on the requirements of a particular embodiment of the invention. In several embodiments, the metrics are retrieved (910) for the pieces of content that perform best according to one or more predetermined criteria (e.g. highest engagement). In many embodiments, the retrieved (910) metrics include engagement (the number of people who have clicked, viewed, shared, propagated to another site, recommended, commented on or “liked” the piece of content in some way), and virality (the proportion of members who engaged with the content and also shared the content with other members of the online social network). In other embodiments, any of a variety of metrics appropriate to a specific application can be utilized.

The retrieved metrics for each piece of content are analyzed (912) and user affinities are indexed (914). In a number of embodiments, processes similar to those described above are utilized to index (914) user affinities based on the members of the online social network (or other users), who have already engaged with a piece of content.

The demographics of users that have engaged with the pieces of content can also be determined (916). In several embodiments, determining (916) user or member demographic information involves utilizing the indexed user affinity information. In many embodiments, the user demographic information is determined (916) using the top N best performing pieces of content according to any of a variety of predetermined measures appropriate to specific applications. Determining (916) user demographic information enables a system to estimate the type of user who may be interested in a piece of content, were the content to be converted into a piece of advertising. In several embodiments of the invention, users who may be interested in the content can be grouped into clusters using processes similar to those described above.

Using the information obtained concerning the pieces of content, specific pieces of content can be targeted (918) as advertisements. In several embodiments, targeting (918) advertisements involves computing the distance between a piece of content and clusters of users. The distance between a piece of content and the cluster of users is based the similarities (or differences) between keywords within the piece of content and the determined (916) user demographic information for the members in the cluster of users. That is, pieces of content with keywords that are well correlated with the demographic information for a cluster of users are considered to be close to the cluster of users, while pieces of content with keywords that are not well correlated with the demographic information for a cluster of users are considered to be remote from the cluster of users. If a cluster of users is close to the piece of content (e.g. within a threshold distance), then that piece of content can be chosen as a targeted (918) advertisement for the proximate cluster of users. For example, there could be two candidate pieces of content, where a significant proportion of people who liked the first piece of content are male and a significant proportion of people who liked the second piece of content are female. In a number of embodiments, a cluster of users as identified as male would be targeted when converting the first piece of content into an advertisement, and a cluster of users identified as female would be targeted when converting the second piece of content into an advertisement. In many embodiments, the selected content is targeted by posting the content as an advertisement using targeting keywords that target a specific cluster of users. The targeting keywords can be determined using any of a variety of processes including (but not limited to) those described above. In other embodiments, any of a variety of techniques can be utilized to target advertisements based upon the characteristics of members that have interacted with specific pieces of content including (but not limited to) affinity information and/or demographic information.

A specific process for selecting and generating targeted advertising based upon the characteristics of users that have already interacted with the content is described above with respect to FIG. 9; however, a number of processes for selecting and generating targeted advertisements for specific pieces of content may be utilized in accordance with embodiments of the invention.

Although the present invention has been described in certain specific aspects, many additional modifications and variations would be apparent to those skilled in the art. It is therefore to be understood that the present invention may be practiced otherwise than specifically described without departing from the scope and spirit of the present invention. Thus, embodiments of the present invention should be considered in all respects as illustrative and not restrictive. Accordingly, the scope of the invention should be determined not by the embodiments illustrated, but by the appended claims and their equivalents.

What is claimed is:

1. A method of targeting a piece of content as a paid advertisement within an online social network, comprising:
retrieving metrics with respect to engagement by members of an online social network with specific pieces of content posted by a member identifying members of a social network that engage with a piece of content using an advertising campaign creation system;
determining user affinities based upon the retrieved metrics with respect engagement by members of the online social network using the advertising campaign creation system;
determining demographics of members of the online social network that have engaged with the pieces of content using the advertising campaign creation system;
identifying at least one cluster of members of the online social network based on the demographics of members of the online social network that have engaged with the pieces of content using the advertising campaign creation system, where the members are clustered based upon targeting information and the targeting information comprises at least one targeting keyword and the members in a cluster of members are associated with a message having the targeting keyword; and
targeting at least one of the specific pieces of content as a paid advertisement targeted based on targeting information associated with the at least one cluster of members of the online social network identified based on the demographics of members of the online social network using the advertising campaign creation system.

2. The method of claim 1, wherein retrieving metrics with respect to engagement by members of an online social network further comprises retrieving the N most recently posted pieces of content by a member using the advertising campaign creation system.

3. The method of claim 1, wherein retrieving metrics with respect to engagement by members of an online social network further comprises retrieving the best performing pieces of content posted by a member using the advertising campaign creation system.

4. The method of claim 1, wherein the retrieved metrics comprise information regarding the virality of the specific pieces of content posted by a member, where the virality of a piece of content is a measure of how many members of the online social network have posted a piece of content related to the specific piece of content posted by the member.

5. The method of claim 1, wherein targeting at least one of the specific pieces of content as a paid advertisement further comprises:
computing the distance between a piece of content and at least one cluster of members based on the keywords associated with the piece of content and the demographics of a cluster of members using the advertising campaign creation system; and
targeting the piece of content to a cluster of members when the piece of content is within a threshold distance from the cluster of members using the advertising campaign creation system.

6. The method of claim 1, further comprising targeting a different set of advertising creatives for each cluster of members in the at least one of cluster of members using the advertising campaign creation system.

7. The method of claim 1, further comprising generating advertising content for a cluster of members based on the targeting information and the specific pieces of content targeted to the cluster of members using the advertising campaign creation system, where the advertising content comprises at least one targeting keyword associated with the cluster of members.

8. The method of claim 7, wherein the advertising content comprises at least one of the targeted paid advertisements.

9. The method of claim 7, further comprising:
generating an advertising campaign comprising the advertising content using the advertising campaign creation system; and
transmitting the advertising campaign to the online social network associated with the members using the advertising campaign creation system.

10. The method of claim 1, further comprising:
identifying additional relevant terms using messages posted to at least one social network based upon the targeted paid advertisements using the advertising campaign creation system; and
targeting additional pieces of content as paid advertisements targeted based on the additional relevant terms and the targeting information associated with the at least one cluster of members of the online social network identified based on the demographics of members of the online social network using the advertising campaign creation system.

11. An advertising campaign creation system, comprising:
a processor; and
memory connected to the processor and configured to store an advertising targeting application;
wherein the advertising targeting application configures the processor to:
retrieve metrics with respect to engagement by members of an online social network with specific pieces of content posted by a member identifying members of a social network that engage with a piece of content;
determine user affinities based upon the retrieved metrics with respect engagement by members of the online social network;
determine demographics of members of the online social network that have engaged with the pieces of content;
identify at least one cluster of members of the online social network based on the demographics of members of the online social network that have engaged with the pieces of content, where the members are clustered based upon targeting information and the targeting information comprises at least one targeting keyword and the members in a cluster of members are associated with a message having the targeting keyword; and
target at least one of the specific pieces of content as a paid advertisement targeted based on targeting information associated with the at least one cluster of members of the online social network identified based on the demographics of members of the online social network.

12. The system of claim 11, wherein the advertising targeting application configures the processor to retrieve metrics with respect to engagement by members of an online social network by retrieving the N most recently posted pieces of content by a member using the advertising campaign creation system.

13. The system of claim 11, wherein the advertising targeting application configures the processor to retrieve metrics with respect to engagement by members of an online social network by retrieving the best performing pieces of content posted by a member using the advertising campaign creation system.

14. The system of claim 11, wherein the retrieved metrics comprise information regarding the virality of the specific pieces of content posted by a member, where the virality of a piece of content is a measure of how many members of the online social network have posted a piece of content related to the specific piece of content posted by the member.

15. The system of claim 11, wherein the advertising targeting application configures the processor to target at least one of the specific pieces of content as a paid advertisement by:
computing the distance between a piece of content and at least one cluster of members based on the keywords associated with the piece of content and the demographics of a cluster of members; and
targeting the piece of content to a cluster of members when the piece of content is within a threshold distance from the cluster of members.

16. The system of claim 11, wherein the advertising targeting application further configures the processor to target a different set of advertising creatives for each cluster of members in the at least one of cluster of members using the advertising campaign creation system.

17. The system of claim 11, wherein the advertising targeting application further configures the processor to generate advertising content for a cluster of members based on the targeting information and the specific pieces of content targeted to the cluster of members, where the advertising content comprises at least one targeting keyword associated with the cluster of members.

18. The system of claim 17, wherein the advertising content comprises at least one of the targeted paid advertisements.

19. The system of claim 17, wherein the advertising targeting application further configures the processor to:
generate an advertising campaign comprising the advertising content; and
transmit the advertising campaign to the online social network associated with the members.

20. The system of claim 11, wherein the advertising targeting application further configures the processor to:
identify additional relevant terms using messages posted to at least one social network based upon the targeted paid advertisements; and
target additional pieces of content as paid advertisements targeted based on the additional relevant terms and the targeting information associated with the at least one cluster of members of the online social network identified based on the demographics of members of the online social network.
